(19) United States
(12) Patent Application Publication
(10) Pub. No.: US 2013/0253264 A1
(43) Pub. Date: Sep. 26, 2013

(54) DEVICE FOR PROMOTING AND INCREASING SEXUAL AROUSAL HAVING A VIBRATION UNIT

(71) Applicant: Okay Canbulat, Hannover (DE)

(72) Inventor: Okay Canbulat, Hannover (DE)

(21) Appl. No.: 13/876,479

(22) PCT Filed: Sep. 27, 2011
(86) PCT No.: PCT/DE11/01781

§ 371 Date: Jun. 11, 2013

(30) Foreign Application Priority Data
Sep. 28, 2010 (DE) 20 2010 012 572.3

(51) Int. Cl. A61H 23/00; A61H 19/00

(52) U.S. Cl. CPC A61H 23/00; A61H 19/32
USPC 600/38; 601/46

(57) ABSTRACT

The invention relates to a device for promoting and increasing sexual arousal, comprising a vibration unit. The device comprises a rear ring and a front ring, by means of which rings the device annularly surrounds a penis in the front and rear regions of the penis. The two rings are connected to each other by means of an intermediate part, which partially covers the penis between the rings. A vibration unit is integrated within the device. The device is made of an elastic, skin-compatible, slippery material.

### TECHNICAL FIELD

The invention relates to a device for promoting and increasing sexual arousal, comprising a vibration unit.

### BACKGROUND

A corresponding device has been disclosed by the document DE 20 2005 000 061 U1, which is designed as a penis ring with a vibration function. The penis ring is attached at the base of the penis in the region of the testicles. However, the stimulation of such penis rings is restricted by virtue of the fact that the vibration only has an effect on the base of the penis. As a result of the superficial arrangement, the vibration cannot affect the whole penis. Moreover, as a result of the superficial arrangement of the vibration, a large part of the vibration dissipates in the air and cannot contribute to increasing the stimulation and promoting the sexual excitation.

Moreover, devices are known in the form of hollow penis-extension elements or extension attachments, which are placed over the glans of the penis as an attachment and which are likewise equipped with a vibration function. Here, too, a significant part of the vibration oscillation remains unused. The effective vibration is restricted to the region of the glans of the penis and the vibration can in this case likewise not be transmitted to the whole penis. Since the glans is completely covered by the extension element, the sensitivity of the penis is reduced during sexual intercourse.

Finally, the document US 2007/0261700 A1 has also disclosed a device, which is embodied as a penis sleeve with a vibration function. The penis sleeve is placed over the whole shaft of the penis and can leave the glans uncovered.

Since the shaft of the penis is completely covered, the sensitivity of the penis during sexual intercourse is disadvantageously reduced when using this device.

The invention is based on the object of developing a device for promoting and increasing sexual arousal which avoids the disadvantages of the known devices and which has a negligibly small influence on the sensitivity of the penis during sexual intercourse and at the same time enables an improved promotion and increase of sexual arousal by means of a vibration unit.

### SUMMARY

The device according to the invention comprises a rear ring and a front ring, by means of which the device completely surrounds a preferably round and elongate body at the front and rear end thereof in an annular fashion. An intermediate part extends between the two rings of the device, which intermediate part partly covers the body in the region between the rings. The vibration unit is arranged and integrated within the device, and the device consists of an elastic, skin-compatible and slippery material.

In an expedient embodiment of the invention, the device consists of silicone. This material is used, inter alia, by make-up artists and in the field of orthopedics and has been found to be particularly advantageous in respect of skin compatibility and in respect of softness, elasticity and slippage.

In a further advantageous embodiment of the invention, the body is formed by a penis. Here, the rear ring of the device can then expediently be arranged at the base of the penis and the front ring can expediently be arranged rearward of the base of the glans of the penis. Depending on user preference, the device can also be placed on the penis in a different fashion.

The device according to the invention results in the penis being increased in its circumference over the length of the device. This is advantageous in the case of males who have complexes due to the lack of thickness of their penis. The lack of thickness is compensated for by the device according to the invention. Moreover, this can also fulfill the wish of the partner to feel something thicker in the genital region during sexual intercourse.

A further advantage in the device according to the invention consists of the fact that it leaves three sides and the glans of the penis uncovered. Only one side or part of the penis is covered by the intermediate body and the base and the region rearward of the glans of the penis is covered by the two rings. Since three sides of the penis and the glans are exposed, the sensitivity of the penis is not or only insignificantly adversely affected during sexual intercourse.

A very significant advantage of the invention should be seen in the fact that the vibration unit is completely integrated into the device, i.e. is situated completely within the device. The effects of the vibration unit or the vibration oscillations therefore extend to the whole device and are not spatially delimited. The device, which vibrates overall when the vibration unit is switched on, in turn transmits the vibration oscillations to the penis, which, as a result thereof, can be re-functioned to be a fully functional vibrator, wherein, to be precise, the sensitivity of the penis remains unchanged.

Since the vibration unit is situated completely within the device and is integrated into the latter, there is the option of pushing the device onto a different elongate object other than a penis. The vibration oscillations are then transmitted to the utilized elongate part, and in this fashion the device can also be used as vibrator by women and can be inserted into the female vagina. The device according to the invention can also be used for anal stimulation.

In accordance with an expedient embodiment of the invention, the battery for operating the vibration unit is an integrated component of the vibration unit itself, wherein the vibration unit can be wirelessly switched on and off by means of a remote control and wherein the intensity of vibration strength can be set.

In this embodiment of the invention, the vibration unit is arranged in replaceable fashion within the device and so the vibration unit can be removed through a small opening in the device when the battery is empty and needs to be replaced by new one. As a result of the elastic material, the small opening can be opened up far enough for it to be possible to remove the vibration unit.

In addition to this, it is also possible for the battery for operating the vibration unit to be arranged outside of the vibration unit and outside of the device in a battery box and to be connected to the vibration unit by means of a cable. The battery box comprises a switching element, by means of which the vibration unit can be switched on and off and by means of which the intensity of the vibration of the vibration unit can be set. The advantage of this solution consists of the fact that it is easier to replace the battery.

In a further advantageous embodiment of the invention, provision is made for a flexible, stretchable attachment ring on the rear ring of the device, by means of which attachment ring the testicles of the penis can be attached to the device. The attachment ring exerts a certain amount of pressure, which is perceived as being particularly pleasurable by some users. Additionally, the attachment ring transfers the vibration to the testicles, as a result of which a stimulating effect is advantageously triggered.

In another advantageous embodiment of the invention, an arc-shaped stiffening element is integrated into the device, which stiffening element has a design which is stiff in the longitudinal direction and flexible in the transverse direction.

As a result of the flexible design in the transverse direction or in the circumferential direction of the penis, the strengthening element can, in terms of its shape, be matched to the arc-shaped circumference of the device. By contrast, the strengthening element has a stiff design in the longitudinal direction of the device. This is advantageous in the case of persons with penile erectile problems. As a result of the stiffness of the inherently elastic device as a result of the strengthening element, the partner feels a stiff penis during sexual intercourse, as a result of which the sexual excitation can be further increased when using the device.

In an expedient embodiment of the invention, the strengthening element substantially extends in the intermediate part of the device and also, in part, in at least one of the two rings of the device.

### BRIEF DESCRIPTION OF THE DRAWINGS

In the following text, the invention will be described in more detail on the basis of the exemplary embodiment illustrated in the drawing. In detail:

FIG. 1 shows a perspective illustration of an exemplary embodiment of a device according to the invention;

FIG. 2 shows a cross-sectional view of the device according to the invention as per FIG. 1, along the cut A-A;

FIG. 3 shows a schematic side view of the device, which is placed onto a penis, as per FIG. 1;

FIG. 4 shows a schematic illustration of the device according to the invention as per FIG. 3, wherein the device is rotated by 180° and the intermediate piece extends on the lower part of the penis;

FIG. 5 shows a schematic side view of the device according to the invention with a stiffening element;

FIG. 6 shows a cross-sectional view of the device according to the invention as per FIG. 5, along the cut B-B, and

FIG. 7 shows a schematic top view of the device according to the invention as per FIG. 5, without penis.

### DETAILED DESCRIPTION

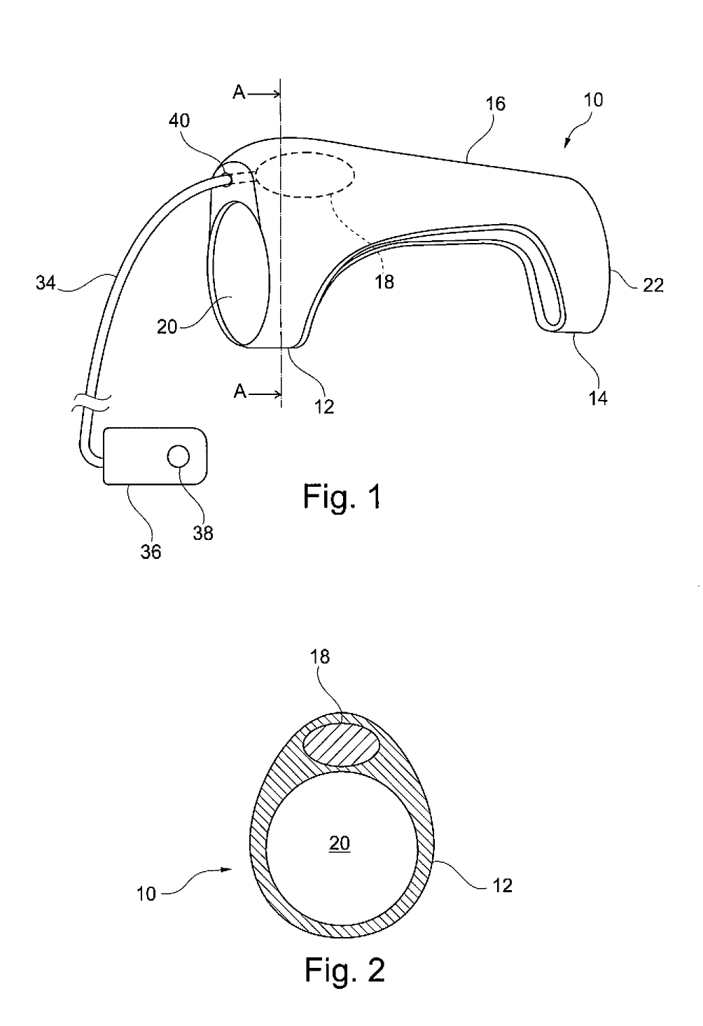

FIG. 1 illustrates, in a schematic perspective illustration, a device 10 which comprises a rear ring 12 and a front ring 14. The rear ring 12 forms a rear opening 20 and the front ring 14 forms a front opening 22.

An intermediate part 16, embodied with an arc-shaped design, extends between the two rings 12, 14 as a component of the integral device 10. The device consisting of one part is made of silicone. This material is particularly skin-compatible, elastic and also slippery.

As can be identified both in FIG. 1 and in the cross-sectional view along the cut A-A in FIG. 2, a vibration unit 18 is, as an integral component, situated within the device 10 in the region of the rear ring 12 in the upper part thereof. The vibration unit is connected to a battery box 36 through a small opening 40 via a cable 34, in which battery box there is a battery (not illustrated) for operating the vibration unit 18. A switching unit 38 of the battery box 36 can be used to switch the vibration unit 18 on and off, and the vibration strength can also be set by the switching element 38.

Additionally, it is also possible to use within the device 10 a vibration unit with an integrated battery. In this case, it is possible to dispense with the cable 34 because said cable is often perceived to be bothersome. The vibration unit is operated wirelessly by means of a remote control.

For the purpose of replacing the battery or replacing the vibration unit 18, the vibration unit 18 can be removed and reinserted through the small opening 40 in the device 10, which small opening can be widened as a result of the elastic material of the device 10.

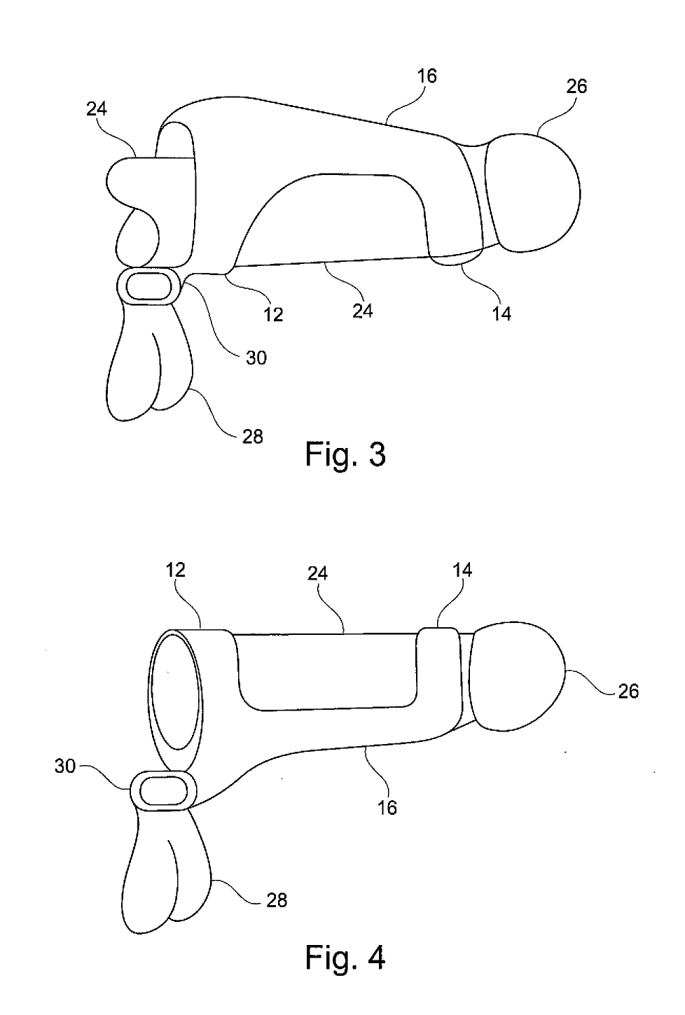

The device 10 illustrated in FIG. 3 shows an extendable flexible attachment ring 34 for male testicles 28 at the base of the penis 24. When the vibration unit 18 is switched on, the vibration is also transmitted to the testicles 28, as a result of which the sexual excitement can be increased even further. The attachment ring 30 is an integral component of the device 30.

FIG. 3 illustrates the usage function of the device 10. The rear ring 12 reaches around the penis 24 at the base thereof and the front ring 14 reaches around the penis 24 rearward of the base of the glans 26. The two rings 12, 14 are interconnected by the intermediate part 16, which, for example, covers the upper half of the penis 24 and leaves the lower side and the two other lateral sides of the penis 24 exposed. The glans 26 is also exposed. As a result, the sensitivity of the penis is maintained during sexual intercourse.

As a result of the integral arrangement of the vibration unit 18 within the device 10, the vibration radius of the vibration unit 18 is extended, and what is achieved is that the whole device 10 vibrates and the vibration oscillations are also transmitted to the penis 24. Herein lies a substantial advantage of the invention because the human penis as a result can, in practical terms, itself be re-functioned to be a fully functional vibrator while the penis remains sensitive.

However, the device 10 according to the invention can also be placed over any other elongate round body and extend around the latter with its two rings 12, 14. During operation of the device, the vibration oscillations are then transmitted to this elongate body. As a result, it is possible for women to use the device 10 with the elongate body as a vibrator, and for example to insert the latter into the vagina. Additionally, the vibrator is also suitable for anal stimulation.

In the usage function of the device 10 illustrated in FIG. 4, the intermediate part 16 is situated adjoining the bottom of the penis 24. In addition to the glans 26, the two side parts of the penis and the upper part of the penis 24 remain exposed in this case. This position of the device 10 is advantageous because the penis 24 is particularly sensitive on the lower side and can easily be stimulated by contact with the vibrating intermediate part 16 and the rings 12, 14. This is due to the fact that a particularly sensitive spongy body of the penis 24 extends at the bottom of the penis 24.

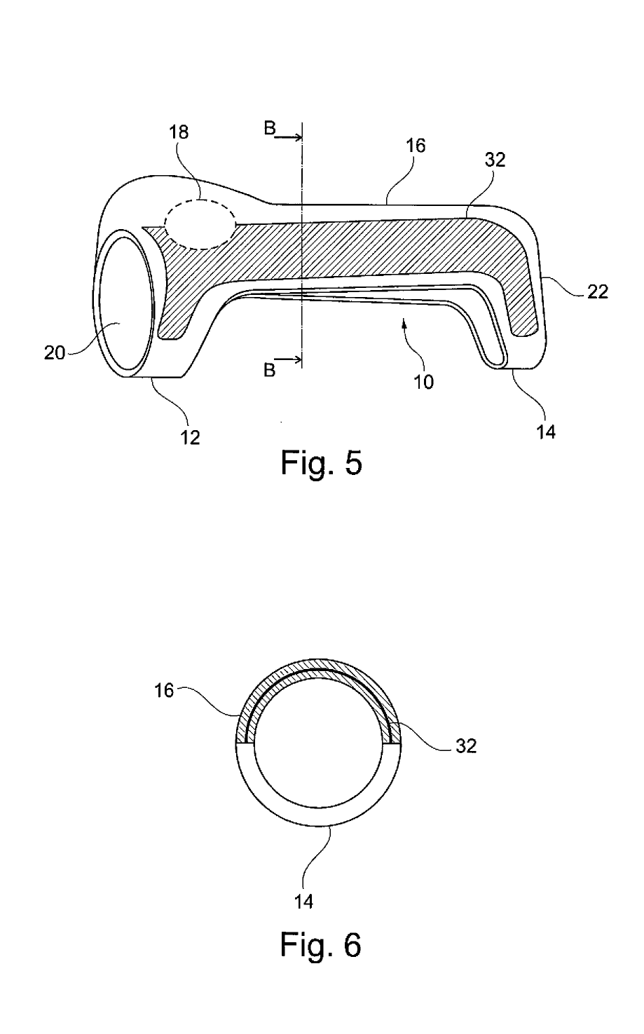

In the embodiment of the invention as per FIG. 5, a stiffening element 32 is integrated within the device, which stiffening element extends over part of the intermediate part and over part of the two rings 12, 14. The vibration unit 18 is arranged above the stiffening element 32.

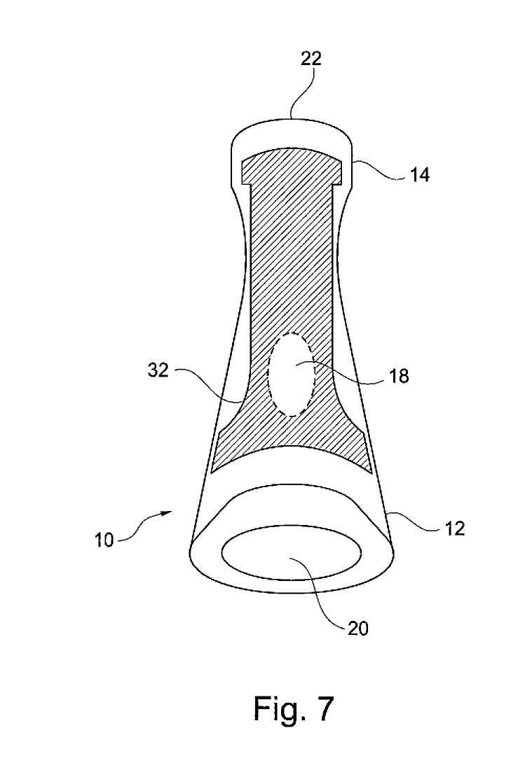

The stiffening element 32 is embodied in the style of a link conveyor, i.e. the stiffening element 32 is flexible in the circumferential direction of the device 10 and stiff in the longitudinal direction of the device 10. The stiffening element 32 overall supports and improves the vibration function of the device 10. The integrated arrangement of the stiffening element 32 is illustrated in the cross-sectional view as per the cut B-B in FIG. 6, and FIG. 7 clarifies the arrangement within the device 10 in a top view.

LIST OF REFERENCE SIGNS

(is part of the description)
10 Device
12 Rear ring
14 Front ring
16 Intermediate part
18 Vibration unit
20 Rear opening
22 Front opening
24 Penis
26 Glans
28 Testicles
30 Attachment ring
32 Stiffening element
34 Cable
36 Battery box
38 Switching element
40 Opening
A Cut
B Cut.

1.-9. (canceled)

10. A device (10) for promoting and increasing sexual arousal, comprising:
a rear ring (12) and a front ring (14) surrounding a preferably round and elongated body (24) at the front and rear end thereof in an annular fashion;
an intermediate part (16) extending between the rear ring (12) and the front ring (14), the intermediate part (16) only partly covering the body (24); and
a vibration unit (18),
wherein the rear ring (12), the front ring (14), and the intermediate part (16) are made of an elastic, skin-compatible, and slippery material.

11. The device as in claim 10, wherein the elastic, skin-compatible, and slippery material is silicone.

12. The device as in claim 10, wherein the body (24) is a penis having a base and a glans (26), and wherein the rear ring (12) is arranged at the base of the penis (24) and the front ring (14) is arranged rearward of the glans (26) of the penis (24).

13. The device as in claim 10, wherein the vibration unit (18) comprises an integrated battery and wherein the vibration unit (18) can be wirelessly switched on and off by a remote control.

14. The device as in claim 10, wherein vibration unit (18) is connected to an external battery box (36) by a cable (34).

15. The device as in claim 14, wherein the battery box (36) comprises a switching element (38), by means of which the vibration unit (18) can be switched on and off and by means of which a vibration intensity of the vibration unit (18) can be adjusted.

16. The device as in claim 12, further comprising a flexible, stretchable attachment ring (30) disposed on the rear ring (12), the attachment ring (30) being suitable to attach testicles (28) of the penis (24) to the device (10).

17. The device as in claim 10, further comprising an arc-shaped stiffening element (32) integrated into the device (10), the stiffening element (32) being longitudinally stiff and transversally flexible.

18. The device as in claim 17, wherein the stiffening element (32) substantially extends in the intermediate part (16) and at least partially in at least one of the rear ring (12) and the front ring (14) of the device (10).
